(19) United States
(12) Patent Application Publication
(10) Pub. No.: US 2025/0062915 A1
(43) Pub. Date: Feb. 20, 2025

(54) CERTIFICATE AUTHORITY FOR AVATAR DIGITAL CERTIFICATE VALIDATION

(71) Applicant: LENOVO (SINGAPORE) PTE. LTD., SINGAPORE (SG)

(72) Inventors: Igor Stolbikov, Morrisville, NC (US); Scott Li, Morrisville, NC (US); Rafael Rodrigues Machado, Morrisville, NC (US); Denis Leite Gomes, Morrisville, NC (US)

(21) Appl. No.: 18/449,633

(22) Filed: Aug. 14, 2023

(51) Int. Cl. H04L 9/32

(52) U.S. Cl. CPC H04L 9/3263; H04L 9/3231

(57) ABSTRACT

In one aspect, a first device includes a processor assembly and storage accessible to the processor assembly. The storage includes instructions executable by the processor assembly to use a certificate authority (CA) device to match, to at least within a threshold, first biometric data indicated in a digital certificate for an avatar to both second biometric data generated based on input from at least one biometric sensor and third biometric data identified from a government-issued identify document. Based on the match, the instructions are executable to validate the digital certificate. The avatar with the validated digital certificate can then be used in an extended reality (XR) computer simulation.

### FIELD

The disclosure below relates to technically inventive, non-routine solutions that are necessarily rooted in computer technology and that produce concrete technical improvements. In particular, the disclosure below relates to digital certificate authority (CA) technology to validate avatar digital certificates.

### BACKGROUND

As recognized herein, virtual interactions in extended reality (XR) environments are becoming more and more commonplace in today's computer-centric world. However, as also recognized herein, often times a person can claim to be anybody they wish in the virtual environment and use a corresponding virtual representation, even if the representation appropriates the name and likeness of another person without authorization. This in turn can lead to digital security issues as well as personal harm to the person that is being impersonated in the virtual environment. There are currently no adequate solutions to the foregoing computer-related, technological problem.

### SUMMARY

Accordingly, in one aspect a first device includes a processor assembly and storage accessible to the processor assembly. The storage includes instructions executable by the processor assembly to, at a certificate authority (CA), identify first biometric data from a digital certificate associated with an avatar. The first biometric data indicates one or more biometrics of a first user. The instructions are also executable to, at the CA, identify second biometric data indicating one or more biometrics of the first user. The second biometric data is generated based on input from at least one biometric sensor. The instructions are further executable to, at the CA, identify third biometric data associated with a government-issued identity document. The third biometric data indicates one or more biometrics of the first user. The instructions are also executable to, at the CA, determine that the first biometric data, the second biometric data, and the third biometric data match to at least within a first threshold. At the CA and based on the determination, the instructions are then executable to validate the digital certificate.

In certain example implementations, the instructions may be executable to, prior to the determination, validate the third biometric data using a government electronic system and execute the determination at least in part based on the third biometric data being validated using the government electronic system. The government electronic system may be associated with a government entity that issued the government-issued identity document.

Also in various example implementations, the first biometric data may be expressed as a first zero-knowledge proof in the digital certificate. Thus, if desired the determination may be made using zero-knowledge proofs that respectively establish the first, second, and third biometric data. So, for example, the instructions may be executable to convert the input from the at least one biometric sensor to a second zero-knowledge proof to make the determination, where the second zero-knowledge proof may establish the second biometric data. Thus, as a specific non-limiting example, the instructions may be further executable to receive the third biometric data in the form of a third zero-knowledge proof to make the determination, where the third zero-knowledge proof may be received from a government entity that issued the government-issued identity document. However, the instructions may be additionally or alternatively be executable to receive the second biometric data as a second zero-knowledge proof from a client device itself to make the determination.

What's more, in certain example embodiments the instructions may be executable to, based on the determination, validate the digital certificate and transmit an indication of validation of the digital certificate to a client device. So, for example, the client device may include a second device from which the second biometric data was received and/or a third device attempting to validate the digital certificate. The third device may be a device associated with a second user different from the first user.

Furthermore, in some example implementations the first device may include a server associated with the CA. Here, the instructions may be executable to receive the digital certificate from a second device different from the first device. The second device may be a client device and may be associated with the first user.

In various example implementations, the avatar may include a three-dimensional (3D) graphical representation of the first user, where the 3D graphical representation may be loadable into at least one computer simulation. So, for example, the instructions may be executable to use a face-forward image of the avatar as generated from graphics data related to the 3D graphical representation to match, to at least within one or more second thresholds and using facial recognition, a face shown in the face-forward image to: a face indicated via the government-issued identity document, and/or a face indicated via fourth biometric data. The fourth biometric data may be related to the first user, may be generated at a client device, and may be the same as or different from the second biometric data. Based on the match of the faces to at least within the one or more second thresholds, the instructions may be executable to validate the digital certificate.

In another aspect, a method includes identifying first biometric data from a digital certificate associated with an avatar. The first biometric data indicates one or more biometrics of a first user. The method also includes identifying second biometric data indicating one or more biometrics of the first user. The second biometric data is generated based on input from at least one biometric sensor. The method also includes identifying third biometric data associated with a government-issued identity document. The third biometric data indicates one or more biometrics of the first user. The method further includes determining that the first biometric data, the second biometric data, and the third biometric data match to at least within a first threshold and then validating the digital certificate based on the determination.

In various example implementations, the digital certificate may be an X.509 certificate.

Also in various example implementations, the method may include both issuing the digital certificate via a certificate authority (CA) and validating the digital certificate via the CA.

In still another aspect, at least one computer readable storage medium (CRSM) that is not a transitory signal includes instructions executable by a processor assembly to use a certificate authority (CA) device to match, to at least within a threshold, first biometric data indicated in a digital certificate to both second biometric data generated based on input from at least one biometric sensor and third biometric data identified from a government-issued identify document. Based on the matching, the instructions are executable to validate the digital certificate.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 is another block diagram of an example network of devices consistent with present principles, with the network including a certificate authority (CA) device and a government electronic system device;

FIG. 4 illustrates example logic in example flow chart format that may be executed by a device consistent with present principles; and

FIG. 5 shows an example X.509 digital certificate extension consistent with present principles.

### DETAILED DESCRIPTION

Among other things, the detailed description below discusses methods of using users' photorealistic avatars in X.509 certificate extensions. The X.509 certificate may be presented to services, apps, and users and used in a collaborative manner. It may allow the service or app to get an authentic avatar and display it to other users during virtual interactions. The X.509 certificate may be created by a trusted authority that has the user's identity documents, photos, and biometric data and is able to confirm the real user's personal identity. The avatar information may then be stored as X.509 extensions.

Present principles also recognize that a centralized avatar authority (CAA), which may take the form of a certificate authority (CA), may be used to issue avatar certificates, validate user identity, and verify an avatar's likeness to the real user.

Accordingly, a CAA may accept government issued identity documents and avatar files.

The CAA may be integrated with several other systems that may work together, including for the ability to read government-provided documents including reading barcodes with the protected info. Thus, integration with government systems may be used to validate a government issued document and/or user biometrics.

The system thus verifies the user and the user's likeliness to the avatar. The system can use government provided documents, photos and biometrics.

Avatars' secure and immutable storage may be used, where avatars files may be stored along with auditable records (e.g., zero-knowledge proofs (ZKPs)). Files may be stored in encrypted format and only accessible with the Avatar X.509 certificate data, for example.

Additionally, private key encryption may be used for avatar certificate data (e.g., to encrypt the data itself).

In terms of user verification, the user may be verified via the following. If the avatar is photorealistic (e.g., high resolution scan of the user themselves), then a face forward rendering (e.g., 2D snapshot) from the avatar can be used to compare with photography-based identifications using images of the user themselves, such as government issued ID photos cross-referenced with a real time image of the user. If the likeliness cross-acceptability threshold is met, then user's ID can be considered acceptable and the avatar itself can be verified as matching the likeness of the actual person controlling the avatar. Additionally, biometrics embedded within the avatar file, ID document and real time photo reading can be used to validate/verify the user if the cross-referencing of all biometric endpoints is within acceptable threshold. A federated or third-party identity provider (IDP) may be used, and if the IDP ID document is deemed acceptable consistent with present principles then it could be considered an acceptable user verification method.

Zero-knowledge proofs for biometrics may also be used consistent with present principles. Thus, government-provided biometrics may be used when available and may be included in the avatar X.509 in the form of a zero-knowledge proofs (ZKP). Thus, biometrics may be stored in ZKPs and the user may be authenticated against the ZKP(s). Biometrics ZKPs in certificates can thus be used by the augmented reality (AR)/virtual reality (VR) devices. AR/VR devices can therefore verify the user biometrics against the avatar certificate, providing an additional level of authentication/authorization and hence increasing digital security.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used, as may a Chrome or Android or Windows or MacOS operating system. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in the art. Where employed, the software instructions may also be embodied in a non-transitory device that is being vended and/or provided, and that is not a transitory, propagating signal and/or a signal per se. For instance, the non-transitory device may be or include a hard disk drive, solid state drive, or CD ROM. Flash drives may also be used for storing the instructions. Additionally, the software code instructions may also be downloaded over the Internet (e.g., as part of an application (“app”) or software file). Accordingly, it is to be understood that although a software application for undertaking present principles may be vended with a device such as the system 100 described below, such an application may also be downloaded from a server to a device over a network such as the Internet. An application can also run on a server and associated presentations may be displayed through a browser (and/or through a dedicated companion app) on a client device in communication with the server.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java®/JavaScript, C# or C++, and can be stored on or transmitted from a computer-readable storage medium such as a hard disk drive (HDD) or solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

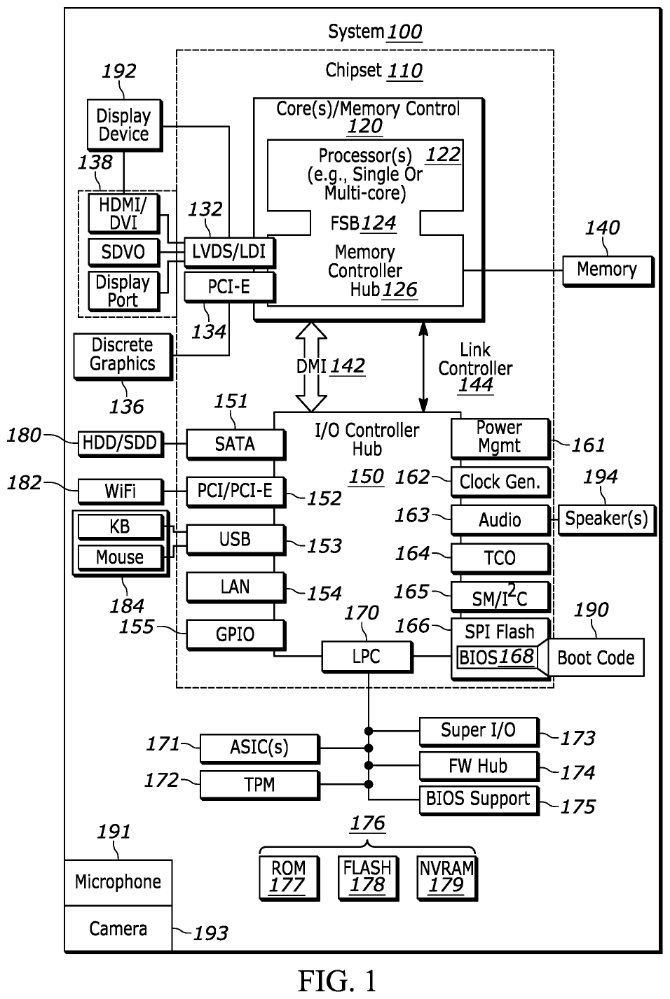

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 includes a processor assembly 122 (e.g., one or more single core or multi-core processors, etc.) and a memory controller hub 126 that exchange information via a front side bus (FSB) 124. A processor assembly such as the assembly 122 may therefore include one or more processors acting independently or in concert with each other to execute an algorithm, whether those processors are in one device or more than one device. Additionally, as described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one or more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 and/or PCI-E interface 152 provide for reading, writing or reading and writing information on one or more drives 180 such as HDDs, SSDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Still further, the system 100 may include an audio receiver/microphone 191 that provides input from the microphone 191 to the processor assembly 122 based on audio that is detected, such as via a user providing audible input to the microphone 191 to speak as part of an XR simulation. The system 100 may also include a camera 193 that gathers one or more images and provides the images and related input to the processor assembly 122. The camera 193 may be a thermal imaging camera, an infrared (IR) camera, a digital camera such as a webcam, a three-dimensional (3D) camera, and/or a camera otherwise integrated into the system 100 and controllable by the processor assembly 122 to gather still images and/or video consistent with present principles. For example, the images/video may be used for eye tracking in XR simulations using cameras 193 facing inward when disposed on a headset, and for location tracking for XR simulations when cameras 193 face outward away from the headset. The camera(s) 193 may also be used to generate a live, real-time image of the user themselves for biometric authentication as disclosed below.

Additionally, though not shown for simplicity, in some embodiments the system 100 may include a gyroscope that senses and/or measures the orientation of the system 100 and provides related input to the processor assembly 122, an accelerometer that senses acceleration and/or movement of the system 100 and provides related input to the processor assembly 122, and/or a magnetometer that senses and/or measures directional movement of the system 100 and provides related input to the processor assembly 122. Also, the system 100 may include a global positioning system (GPS) transceiver that is configured to communicate with satellites to receive/identify geographic position information and provide the geographic position information to the processor assembly 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

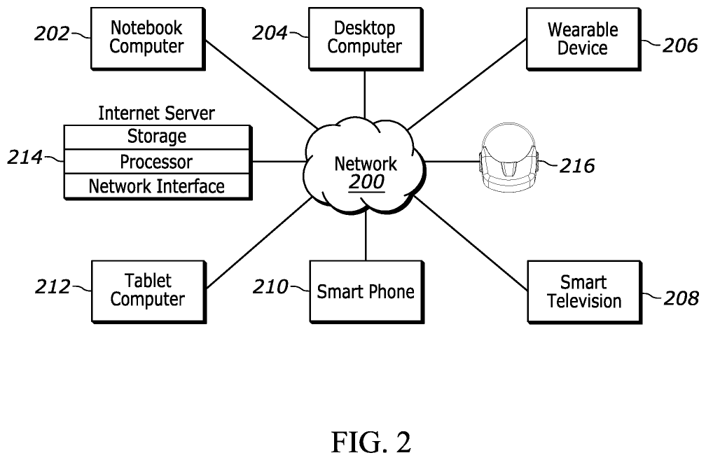

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, an XR headset 216, a server 214 such as an Internet server that may provide cloud storage accessible to the devices 202-212, 216. It is to be understood that the devices 202-216 may be configured to communicate with each other over the network 200 to undertake present principles.

Describing the headset 216 in more detail, note that it may include a non-transparent or transparent “heads up” display. The display may have discrete left and right eye pieces for presentation of stereoscopic images and/or for presentation of 3D virtual images/objects using augmented reality (AR) software, virtual reality (VR) software, mixed reality (MR), and/or another type of XR software consistent with present principles. In various examples, the headset 216 may be a head-circumscribing XR headset to facilitate AR, VR, and/or MR virtual interactions. Additionally or alternatively, the headset 216 may be established by computerized smart glasses or another type of XR headset that presents 3D virtual objects/content consistent with present principles. However, also note that XR simulations that show avatars consistent with present principles may be presented on other display/device types as well, such as smartphones and tablet computers.

It is to be understood consistent with present principles that a real-life end user may create a digital avatar for use in a virtual world, such as the metaverse or another type of AR/VR/MR simulation (more generally, an extended reality (XR) computer simulation). Thus, the user may use one of her cameras on her smartphone or other client device to take one or more pictures of her face while she exhibits a neutral facial expression. Then the user may use the camera(s) to take more or more pictures of her face while she exhibits facial expressions such as smiling and frowning. Then by itself or in conjunction with a remotely-located server, the smartphone may use the images from the camera to generate a digital three-dimensional (3D) model of the user's face that may then be used as a photorealistic avatar for the user to ultimately use the avatar in one or more different XR simulations/virtual worlds.

Various types of software may therefore be executed by the phone to generate the photorealistic avatar, such as FaceBuilder, Blender, FaceGen, Adobe, Photo Crop to Avatar, PetaPixel, etc.

After the avatar has been created and stored as avatar file data, the avatar file data may be uploaded to a server of a certificate authority that issues digital certificates consistent with present principles (e.g., using private key encryption). User data such as biometrics, driver's license information, avatar identity (ID), avatar storage location, and other types of data may also be uploaded to the server. The certificate authority itself may be, for example, the ITU Telecommunication Standardization Sector (ITU-T), though other suitable authorities may also be used. The digital certificates that are issued may be X.509 certificates using the ITU standard, though other types of digital certificates may also be used like those in RFC format.

Once the desired information is uploaded, the smartphone may receive back a digital certificate that encapsulates/indicates some or all of the user's information. The digital certificate may also include a digital signature from the certificate authority, with the digital signature signing the file data of the user's avatar and/or signing the digital certificate itself. The file data may therefore be signed with the certificate authority's private key so that it may be validated later by a client device or server using the authority's public key.

After that, the user may use her smartphone and/or a coordinating server to load the avatar/file data and digital certificate into a virtual VR simulation and then control the avatar within the VR simulation. The server/smartphone may also present the user's certificate to other users that are also participating in the simulation and that might even encounter the user's avatar within the simulation. The client devices of the other users that are presented with the digital certificate may then authenticate the avatar as being associated with the user herself using the digital certificate.

Thus, in one example, the user may hold up to the camera her government-issued driver's license, passport, or other ID document that has a photo of her face on it for the certificate authority to then match biometric data from the ID photo itself to the biometric data just acquired from the user's camera. The certificate authority may also use the ID document to validate its information by comparing the ID document information to ID information provided by the government agency itself that issued the ID document to thus authenticate/verify the user herself. In some examples, this back and forth with the government agency may be done using a zero-knowledge proof algorithm. Then after the data above has been uploaded, the user may command/authorize the certificate authority to perform/complete this verification process and then issue a digital certificate for the user/avatar.

Then when the user goes to participate in an XR simulation such as a metaverse simulation or VR video game, the user may upload the digital certificate to the XR simulation and/or present it to another person through the XR simulation upon request from the other person. This may help demonstrate that the avatar is really being controlled by the user herself rather than someone faking the user's likeness within the simulation via the photorealistic avatar of the user. Thus, assuming the avatar has been authenticated via the digital certificate, the user's avatar may be assigned a universal “authenticated” or “verified” status flag within the simulation so that other end-users may be notified accordingly.

Thus, present principles also deal with another end-user accessing file data for the first end-user's avatar when desired, including accessing graphics data usable to render the avatar on a display/within the simulation itself. The graphics data may therefore include 3D modeling data and feature point data, image data, texture data, color data, etc. for visually rendering the first end user's avatar. The graphics data and associated digital certificate may be received from the client device of the first end user based on the request from the second end-user and/or based on the first end-user uploading the data themselves.

The second user's client device may then use a CA to validate the digital certificate, including validating the digital signature in it that has signed the avatar file data itself to thus verify that the file data as also currently loaded/used to render the first end-user's avatar within the simulation has in fact already been tied to the first end-user's verified real-world identity by the CA (e.g., as also indicated in the digital certificate). Other data that may be indicated in the digital certificate and validated for even greater security include an avatar signature, avatar zero-knowledge proofs, access keys to the avatar file data/identity image files, a real-life photograph of the associated user themselves, and zero-knowledge proofs related to the user's biometrics consistent with present principles (such as facial feature points, ear lobe signature, iris signature, and/or fingerprint signature).

Based on the authentication, the second user's client device may permit virtual interaction between the first end-user and the second end-user within the simulation by permitting their respective avatars to interact in the virtual environment and allowing the two users to themselves exchange other data such as voice streams for bidirectional audio communication. Other types of interactions (beyond the exchange of avatar file data and digital certificates) may also be permitted. But it is to be further understood that in some examples, virtual “physical” interactions between the avatars as well as telephonic or other audio communication between the two end users themselves may only be enabled between digital-certificate-authenticated users to further enhance digital security.

Note more generally as described herein that the avatar or other graphical representation of a user (e.g., video game character) for use in an XR simulation may represent the likeness of the associated person themselves. So in one specific example, a user may submit avatar file data to a CA (certificate authority) along with an image of an ID document like a driver's license or ID card. The CA might then verify that the ID document as presented to it match records available from a reliable third-party source such as the issuing government agency itself. The certificate authority may then also use an artificial intelligence-based model such as a trained convolutional neural network to determine whether the avatar's face matches that of the real-life user to at least within a threshold level of confidence. The threshold level of confidence may be high enough to ensure the avatar exhibits the likeness of the person themselves but still low enough to account for pixelation and other cross-domain issues that might arise when comparing a photograph to a computer-generated avatar image. As such, the threshold level of confidence may be in the range of 65-70% in certain non-limiting examples. Then responsive to the user's face matching the avatar's face to the threshold level of confidence, the device/certificate authority may include an additional extension in the digital certificate itself, possibly signed via the authority's digital signature, that includes a certification that the avatar image matches the likeness of its real-life user (as themselves authenticated through the user's ID).

Also consistent with present principles, note that X.509 extensions or whatever other type of digital certificate is being used may be supported by an immutable, privacy-protecting, avatar identity system in certain non-limiting implementations. The system may be associated with the simulation platform itself and may store large files related to the avatar (e.g., avatar file data). The system may still be publicly accessible and/or may be a global file system with encryption. The system might even be broken up into two services—one to generate the digital certificate itself and one to verify things later as a certificate authority when the digital certificate is presented by/to someone else.

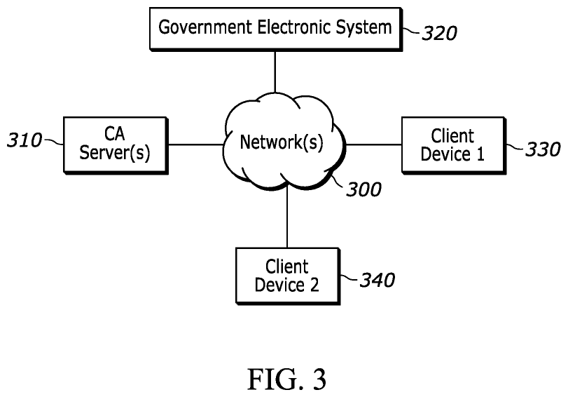

With the foregoing in mind, reference is now made to FIG. 3. This figure shows another example network 300 of devices that may be used consistent with present principles. The devices may communicate over the Internet, a wide area network, a local area network, a wireless 5G network, and/or another communication network using secured/encrypted communication consistent with present principles.

FIG. 3 shows one or more certificate authority (CA) servers 310 operating a portal through which client devices may create avatar digital certificates and also later submit avatar digital certificates for validation consistent with present principles. The portal may therefore be used to present client device-side graphical user interfaces (GUIs) for end-users to interact with the portal as set forth above when, for example, encountering other avatars in an XR simulation. The portal may also be used as a back-end service of the CA for the CA to validate the digital certificates it receives through the portal. And note that the CA may have initially helped generate and issue the certificates themselves as set forth above.

FIG. 3 also shows that a government electronic system 320 established by one or more government client devices and/or government servers may also communicate with other devices over the network 300. The government electronic system 320 may store identity information related to one or more different types of identification, such as international passports, driver's licenses, and/or state-level identification cards. The stored identity information may include copies of images/photos affixed to the corresponding physical paper identity document itself. The stored information may also include other information such as biometric data of the respective people associated with the respective identity documents. The biometric data may be stored in raw and/or unencrypted form, and/or may be stored as a zero-knowledge proof generated through an encryption or hash function.

Thus, a first client device 330 and a second client device 340 may interact with each other in a computer simulation as set forth above, with one client device 300 presenting the digital certificate of its respective end-user to the other client device 340 for the other client device 340 to validate the digital certificate consistent with present principles.

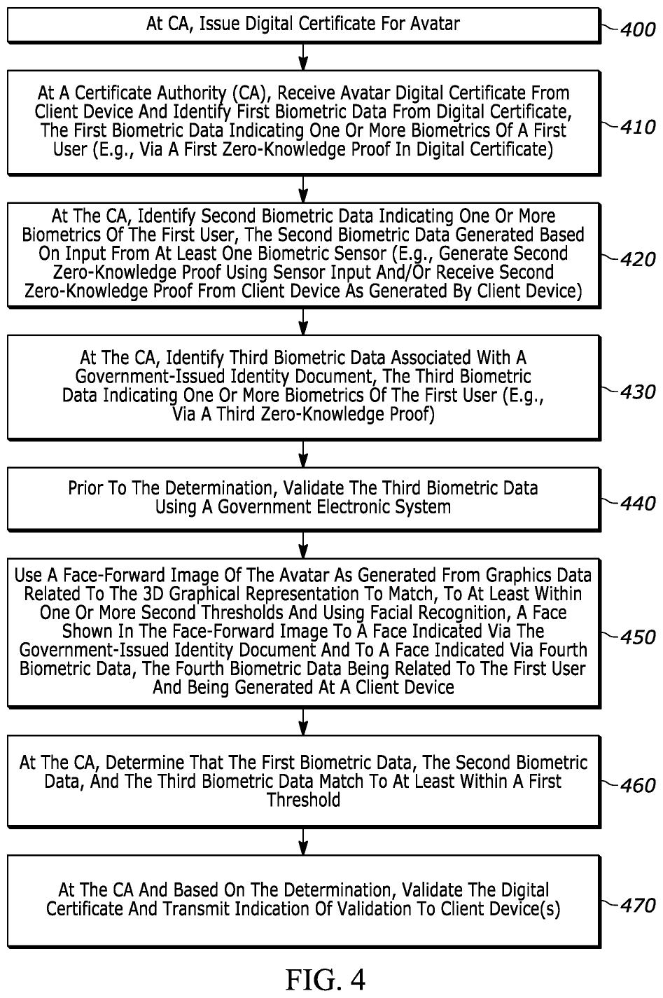

Accordingly, reference will now be made to FIG. 4, which shows example logic that may be executed by one or more devices consistent with present principles, such as one or more processor assemblies in one or more certificate authority (CA) servers. Note that while the logic of FIG. 4 is shown in flow chart format, other suitable logic may also be used.

Beginning at block 400, the device may, at the CA, issue a digital certificate for an avatar consistent with present principles. For example, at block 400 the device may interact with a user's client device through a portal as set forth above to create an avatar in the likeness of a user as well as to create an associated digital certificate for the avatar. As such, the avatar may include a three-dimensional (3D) graphical representation of that user, with the 3D graphical representation being loadable into at least one computer simulation consistent with present principles. From block 400 the logic may then proceed to block 410.

At block 410 the device may, at the CA at a later time, receive the avatar digital certificate from a client device such as the avatar user's own client device or the client device of another person seeking to validate the user's digital certificate prior to interacting with the user in the computer simulation. Thus, also at block 410, the device may identify first biometric data from the digital certificate, with the first biometric data indicating one or more biometrics of the first user. The first biometric data may therefore be in the form of raw/pre-processed biometric data, or for more security, the first biometric data may be expressed as a first zero-knowledge proof in the digital certificate, with the first zero-knowledge proof encoding the raw/pre-processed biometric data itself and being generated during certificate issuance at block 400. Example biometrics that may be encapsulated in the first zero-knowledge proof consistent with present principles include eyes/iris pattern, facial feature data, and fingerprints. As such, the first biometric data in the digital certificate may be zero-knowledge proof versions (e.g., cryptographic hashes) of the first user's unique eye identification (ID) data, facial ID data, and/or fingerprint ID data.

From block 410 the logic may then proceed to block 420. At block 420 the device may, at the CA, identify second biometric data also indicating one or more biometrics of the first user, where the second biometric data may be generated based on real-time input from at least one biometric sensor on the user's client device. For example, the CA server(s) may receive raw or pre-processed biometric data from a biometric sensor on the user's client device and then convert that raw/pre-processed input data to a second zero-knowledge proof, with the second zero-knowledge proof establishing its own form of biometric data. The sensor might be, for example, a camera showing the user's face or iris so that facial/iris recognition can then be executed to extract iris or facial feature biometric data and convert it to a ZKP version. The sensor might also be a fingerprint reader so that fingerprint feature data may be output by the reader and converted to a ZKP version. Other forms of biometric sensors and associated biometric data may also be used and converted to ZKP.

However, in addition to or in lieu of converting raw or pre-processed biometric data to a second zero-knowledge proof at the CA at block 420, note that the user's client device might itself convert the raw/pre-processed data above to the second zero-knowledge proof and then send the zero-knowledge proof itself over the network to the CA server(s), thus helping to further improve digital security by not sending the decipherable raw/pre-processed data over the network. Accordingly, at block 420 the CA server(s) may additionally or alternatively receive the second zero-knowledge proof from the client device.

From block 420, the logic of FIG. 4 may continue to block 430. At block 430 the device may, at the CA, identify third biometric data associated with a government-issued identity document (e.g., driver's license or passport), with the third biometric data indicating one or more of the same biometrics of the first user (same as the ones indicated via the first and second biometric data). Furthermore, note that here too in some examples the third biometric data may be encoded as a third zero-knowledge proof.

As an example, the first end user's passport or driver's license may be held up to the first end-user's smartphone camera for the smartphone to use its camera to scan a barcode, quick response (QR) code, or other code on the ID document to lookup the third biometric data at a remote electronic storage area indicated in the code. The third zero-knowledge proof may therefore be accessed as stored at the remote electronic storage area itself. This remote storage area might be hosted/located on the issuing government's electronic system servers, for example. Also note here that the third zero-knowledge proof may indicate biometric data (e.g., in hashed form) that might have been provided when the user initially applied for the ID document, and might still include iris signature, facial ID data, fingerprint data, etc.

As another example, the third biometric data might be from a digital photograph of the hard copy version of the associated ID document photo itself, so that iris and/or facial recognition can be executed on the photo within the photo (to identify biometric data from the hard copy ID document photo as captured in the digital photo from the user's smartphone camera). The identified raw/pre-processed biometric ID data may then be used to generate a zero-knowledge proof version of the biometric ID data to establish the third zero-knowledge proof of block 430. And note that the digital photo of the government-issued ID itself may be, in non-limiting examples, a PDF scan of the ID document/hard copy photo or a JPEG image of the government-issued ID as held up to the user's smartphone camera to generate a photo of the hard copy ID (and hence digitally capture the inset hard copy ID photo). Additionally, note that in embodiments where fingerprint data is used, the user's fingerprint might be shown on the front or back face of the ID document, and hence the fingerprint may also be identified from a digital photo of the hard copy ID document as captured using the user's smartphone.

From block 430 the logic may then proceed to block 440. At block 440 and in examples where the third biometric data of block 430 was identified using a smartphone camera (or other client device camera) rather than looked up electronically directly from a secured, official government electronic system, the device may attempt to validate the third biometric data from the ID document using the government electronic system itself. This might include comparing and attempting to match biometric data identified from the photo of the hard copy of the ID document to biometric data already stored at the government electronic system. Accordingly, an agreed-upon encryption/hash algorithm may be used to generate both the ZKP of the relevant biometric as stored at the government system, and to generate the ZKP version of the biometric ID data read from the hard copy photo of the ID document as held up to the user's smartphone camera. Responsive to a match, the third biometric data read from the hard copy of the ID document may thus be validated. And again note that the government electronic system itself may be associated with the government entity that issued the government-issued ID document that was imaged with the user's smartphone camera.

From block 440 the logic may then proceed to block 450 to verify the user's likeness in relation to the avatar. At block 450 the device may therefore access the three-dimensional (3D) model data for the user's avatar to then capture or generate a face-forward image of the avatar using the 3D model (e.g., image showing the avatar's face from a perspective in front of and level with the avatar's face). The device may then try to match, to at least within one or more second thresholds and using facial recognition, a face shown in the face-forward avatar image to one or both of a face shown on the hard copy of the government-issued ID document (as captured using the smartphone camera or accessed from a government electronic system) and a face indicated via fourth biometric data related to the user.

In some examples, the fourth biometric data may be real-time data identified using one or more digital photographs of the user using his/her smartphone. Thus, if a digital photograph was used for the second biometric data, the same digital photograph may be used at step 450. Or, if desired, a different digital photograph may be generated specifically for step 450.

Also note here that step 450 may be performed when the user's avatar is made in the likeness of the user themselves, and so the avatar would exhibit facial features and other biometric data matching the real-life user themselves. In executing step 450, the device may therefore match the user's avatar appearance to the user as they've presented themselves to their camera in real time, and to match the user's avatar appearance to the user as shown in the government ID document photo of the user. This likeness cross-referencing may thus help ensure that the avatar in the likeness of the person is currently being controlled by the government-authenticated person themselves, helping increase digital security in the virtual world since people would naturally assume the avatar was being controlled by the actual person when only seeing the avatar in the computer simulation (thus providing assurance that the person they're interacting with behind the avatar is actually the user themselves).

Also note that the one or more second thresholds referenced above may pertain to a same level of confidence in the facial recognition results or different levels of confidence, depending on implementation. Thus, one level of confidence may be used when comparing the face-forward avatar image to the real time digital photo of the user from their smartphone camera, and another level of confidence may be used when comparing the face-forward avatar image to the hard copy ID photo of the user on the tangible, physical ID document itself. Either way, given that facial data is being compared across two different domains of data (3D graphics data and real-life photos), the threshold level of confidence for the facial recognition match may be lower than when comparing across a same domain of data. Therefore, the threshold level of confidence might only be between sixty-five and seventy percent in certain non-limiting examples.

From block 450 the logic may then proceed to block 460 (e.g., based on the match of the avatar/real faces to at least within the one or more second thresholds, and/or based on validating the third biometric data using the government electronic system at block 440). At block 460, the device may, at the CA, determine that the first biometric data from the digital certificate, the second biometric data generated based on sensor input, and the third biometric data associated with the government-issued ID document match to at least within a threshold level of confidence. For example, the match may be an exact match of the respective first, second, and third ZKPs of the biometric as generated using a common encryption/hash algorithm. Or if raw/pre-processed biometric data is being used for some reason, the raw/pre-processed first, second, and third biometric data may be matched at least to within a threshold level of confidence (e.g. ninety percent).

Assuming a match has been determined at block 460, at block 470 the device may then, at the CA and based on the determination, validate the digital certificate itself as being valid. As such, a notification/indication may be electronically transmitted to the client device(s) of end users seeking validation of the digital certificate. In response to receiving the electronic notification, the client device(s) may present a graphical user interface (GUI) with a text notification attesting that avatar's digital certificate and hence the avatar tied to the certificate have been validated as being controlled by the end-user themselves (whose likeness is represented by the avatar). Note here that the GUI may therefore be presented on the display of a client device from which the second biometric data was received (e.g., the client device of the end-user themselves who is represented by the avatar) and/or the display of a client device of another person that is attempting to validate the digital certificate when interacting with the user's avatar in a computer simulation.

It may now be appreciated that an end-user with a digital certificate for a certain photorealistic avatar can prove to a CA (and other end-users) through biometrics that the person controlling the user's photorealistic avatar is in fact the user themselves, possibly without revealing the raw/pre-processed biometric data itself through the use of zero-knowledge proofs. These proofs might be non-interactive zero-knowledge proofs in certain non-limiting examples, as may be generated using zk-SNARK (Succinct Non-Interactive Arguments of Knowledge), Bulletproofs (BBBPWM17), zk-STARKs (BBHR18), and/or the Universal Zero-Knowledge proof algorithm. The hash of the 3D model data for the avatar itself as located in the digital certificate may also be validated against a copy of the hash for the 3D model data as already stored at the CA itself (e.g., stored during digital certificate issuance, with a copy of the 3D model data itself also possibly being stored at the CA during issuance).

The digital certificate may therefore be validated along with user biometrics every time the user uses a given extended reality (XR) device in certain non-limiting examples, or at least before being permitted to enter a computer simulation using the XR device, regardless of whether the XR device is a smartphone, laptop, headset, or other type of device. Thus, even if the avatar file (e.g., 3D model) is public knowledge, it may be stored in secure storage of the CA and may be distributed by the CA for loading into computer simulations, and the CA may privately attest that associated user has the appropriate authority to use the public avatar.

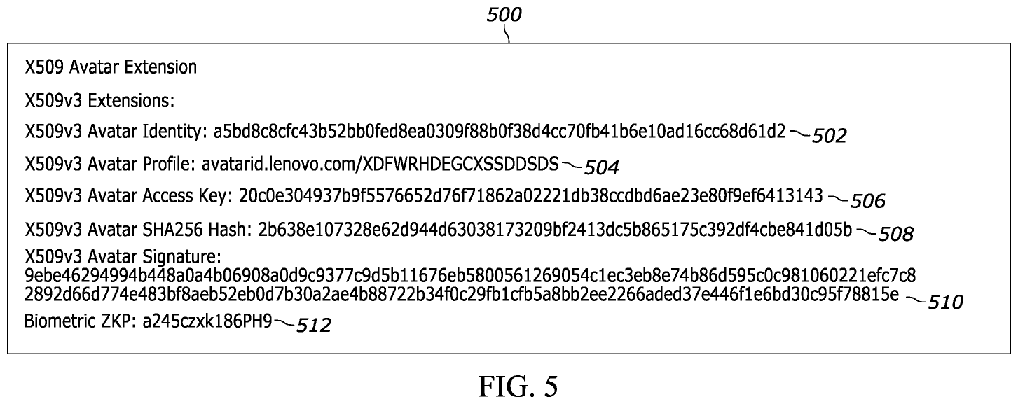

Now in reference to FIG. 5, an example digital certificate 500 is shown that may be used consistent with present principles, which in this case is an X.509 avatar certificate extension. As shown, example extensions/data that may be included are avatar ID 502, a storage location 504 at which the avatar profile and/or file data may be accessed (e.g., 3D model data and biometric ZKPs), and an avatar access key 506 as may be required in some examples to access an encrypted or password-protected version of the profile/file data itself at the storage location 504. A checksum/hash 508 of the profile/file data may also be included for validation purposes, along with a digital signature 510 signed by the digital certificate's issuing certificate authority. Again note that the signature 510 may sign the digital certificate and/or avatar file data itself (including graphics/rendering data), and/or may even sign the associated biometric ZKPs.

Therefore, note that other data may also be included in the digital certificate, including a biometric zero-knowledge proof 512 that may be used for digital certificate validation as set forth above. The ZKP 512 may thus be related to one or more of the user's biometrics (such as ear lobe signature, iris signature, and/or fingerprint signature) for the associated user to be validated in real time through the ZKP 512 during simulation execution using real time images of the user's lobe/iris/fingerprint as captured by their client device during their participation in the virtual simulation. Driver's license or other government ID information may also be included in the digital certificate for validation of biometrics against a driver's license or other ID (e.g., with the ID being presented by the associated user themselves to a camera on their device before or during participation in the virtual simulation). These techniques may provide an added layer of digital security in case someone else gains control of the user's device or photorealistic avatar itself (and hence has access to the user's legitimate digital certificate as might be stored on his/her device).

It may now be appreciated that present principles provide for an improved computer-based user interface that increases the digital security of the devices and computer simulations disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A first device, comprising:
a processor assembly; and
storage accessible to the processor assembly and comprising instructions executable by the processor assembly to:
at a certificate authority (CA), identify first biometric data from a digital certificate associated with an avatar, the first biometric data indicating one or more biometrics of a first user;
at the CA, identify second biometric data indicating one or more biometrics of the first user, the second biometric data generated based on input from at least one biometric sensor;
at the CA, identify third biometric data associated with a government-issued identity document, the third biometric data indicating one or more biometrics of the first user;
at the CA, determine that the first biometric data, the second biometric data, and the third biometric data match to at least within a first threshold;
at the CA and based on the determination, validate the digital certificate.

2. The first device of claim 1, wherein the instructions are executable to:
prior to the determination, validate the third biometric data using a government electronic system and execute the determination at least in part based on the third biometric data being validated using the government electronic system.

3. The first device of claim 2, wherein the government electronic system is associated with a government entity that issued the government-issued identity document.

4. The first device of claim 1, wherein the first biometric data is expressed as a first zero-knowledge proof in the digital certificate.

5. The first device of claim 4, wherein the determination is made using zero-knowledge proofs that respectively establish the first, second, and third biometric data.

6. The first device of claim 5, wherein the instructions are executable to:
to make the determination, convert the input from the at least one biometric sensor to a second zero-knowledge proof, the second zero-knowledge proof establishing the second biometric data.

7. The first device of claim 5, wherein the instructions are executable to:
to make the determination, receive the second biometric data as a second zero-knowledge proof from a client device.

8. The first device of claim 6, wherein the instructions are executable to:
to make the determination, receive the third biometric data in the form of a third zero-knowledge proof, the third zero-knowledge proof received from a government entity that issued the government-issued identity document.

9. The first device of claim 1, wherein the instructions are executable to:
based on the determination, validate the digital certificate and transmit an indication of validation of the digital certificate to a client device.

10. The first device of claim 9, wherein the client device comprises one or more of: a second device from which the second biometric data was received, a third device attempting to validate the digital certificate, the third device being a device associated with a second user different from the first user.

11. The first device of claim 1, wherein the first device comprises a server associated with the CA, and wherein the instructions are executable to:
receive the digital certificate from a second device different from the first device, the second device being a client device, the second device associated with the first user.

12. The first device of claim 1, wherein the avatar comprises a three-dimensional (3D) graphical representation of the first user, the 3D graphical representation being loadable into at least one computer simulation.

13. The first device of claim 12, wherein the instructions are executable to:
use a face-forward image of the avatar as generated from graphics data related to the 3D graphical representation to match, to at least within a second threshold and using facial recognition, a face shown in the face-forward image to a face indicated via fourth biometric data, the fourth biometric data being related to the first user and being generated at a client device; and
based on the match of the face shown in the face-forward image to the face indicated via the fourth biometric data, validate the digital certificate.

14. The first device of claim 12, wherein the instructions are executable to:
use a face-forward image of the avatar as generated from graphics data related to the 3D graphical representation to match, to at least within a second threshold and using facial recognition, a face shown in the face-forward image to a face indicated via the government-issued identity document; and
based on the match of the face shown in the face-forward image to the face indicated via the government-issued identity document, validate the digital certificate.

15. The first device of claim 12, wherein the instructions are executable to:
use a face-forward image of the avatar as generated from graphics data related to the 3D graphical representation to match, to at least within one or more second thresholds and using facial recognition, a face shown in the face-forward image to a face indicated via the government-issued identity document and to a face indicated via fourth biometric data, the fourth biometric data being related to the first user and being generated at a client device; and
based on the match of the faces to at least within the one or more second thresholds, validate the digital certificate.

16. The first device of claim 15, wherein the fourth biometric data is different from the second biometric data.

17. A method, comprising:
identifying first biometric data from a digital certificate associated with an avatar, the first biometric data indicating one or more biometrics of a first user;
identifying second biometric data indicating one or more biometrics of the first user, the second biometric data generated based on input from at least one biometric sensor;
identifying third biometric data associated with a government-issued identity document, the third biometric data indicating one or more biometrics of the first user;
determining that the first biometric data, the second biometric data, and the third biometric data match to at least within a first threshold;
based on the determination, validating the digital certificate.

18. The method of claim 17, wherein the digital certificate is an X.509 certificate.

19. The method of claim 17, comprising:
issuing the digital certificate via a certificate authority (CA) and validating the digital certificate via the CA.

20. At least one computer readable storage medium (CRSM) that is not a transitory signal, the at least one CRSM comprising instructions executable by a processor assembly to:
use a certificate authority (CA) device to match, to at least within a threshold, first biometric data indicated in a digital certificate to both second biometric data generated based on input from at least one biometric sensor and third biometric data identified from a government-issued identify document; and
based on the matching, validate the digital certificate.
